(19) United States
(12) Patent Application Publication
(10) Pub. No.: US 2003/0167242 A1
(43) Pub. Date: Sep. 4, 2003

(54) Retail security system and process

(76) Inventor: Daryl Hamilton, Hyattsville, MD (US)

Correspondence Address: Ivan Mlachak, Lewis & Roca, LLP, 40 N. Central Ave., Phoenix, AZ, 85004, US

(21) Appl. No.: 10/361,486

(22) Filed: Feb. 5, 2003

Related U.S. Application Data
(60) Provisional application No. 60/354,418, filed on Feb. 5, 2002.

(51) Int. Cl. G06F 17/00

(52) U.S. Cl. 705/405; 705/404

(57) ABSTRACT

A system and method is described to provide security for retail transactions with the United States Postal Service. Information related to a purchaser is captured and is electronically linked with the transaction item or service. A barcode providing the linking information is printed and may be attached to a mailpiece. Information that may be recorded includes a digital image of the purchaser, name, address, drivers license number, social security number, and other identifying information. Searching of the customer information against databases of suspected individuals will flag mailed items for further inspection or attention.

### CROSS-REFERENCE TO RELATED APPLICATIONS

This application claims priority from U.S. Provisional Application No. 60/354,418 filed on Feb. 5, 2002, entitled “Retail Security System and Process.” The contents of the above application is relied upon and expressly incorporated by reference as if fully set forth herein.

### STATEMENT REGARDING FEDERALLY SPONSORED RESEARCH OR DEVELOPMENT

The invention was made by an agency of the United States government or under a contract with an agency of the United States government, the United States Postal Service (“USPS” or “Postal Service“), an independent establishment of the executive branch of the U.S. government.

### BACKGROUND OF THE INVENTION

This invention relates to the tracking of retail products and services. In particular the invention relates to the tracking of retail products and services accepted or purchased at USPS retail windows or through any other USPS retail mechanism. The scope of this process should not be restricted to USPS retail mechanisms, but should also extend to other mechanisms of similar organizations where applicable. More particularly the invention identifies the purchaser of the product or service by capturing and recording the customer's image and electronically linking the image to a unique bar code or other identification tool associated with the customer's purchased product or service.

### SUMMARY OF THE INVENTION

It is an object of this invention to provide a method of uniquely identifying the products and services sold at a USPS and non-USPS retail facilities and retail mechanisms through a unique barcoded label or other unique ID to the purchased product or service.

Another object of the invention is to utilize security-monitoring equipment to electronically link the digitized image of the customer to unique product and service identifiers, and match the digitized image against a database of suspected persons using biometric facial recognition technology.

Yet another object of the invention is to track the flow of products to provide near real time information for internal use and for customer use.

These and other objects of this invention can be accomplished by the following methods by:

Positively matching a customer's transaction and the product or service sold to the image of a customer at the point of sale.

Providing traceability to products and services transported by carriers.

Allowing containment and isolation of products and services throughout a supply chain network.

### BRIEF DESCRIPTION OF THE DRAWINGS

For the more detailed description of a preferred embodiment of the present invention, reference will now be made to the accompanying drawings, which form a part of the specification, and wherein:

FIG. 1 depicts the flow plan of the system without a security camera interface.

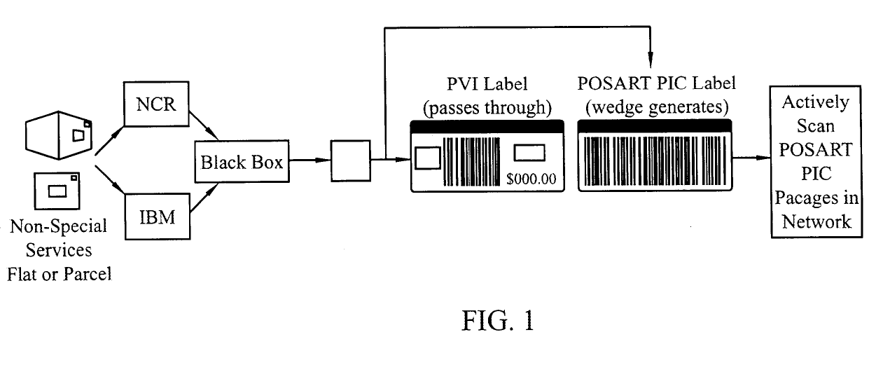

FIG. 2 depicts the flow plan of the system without a security camera interface in a preferred embodiment.

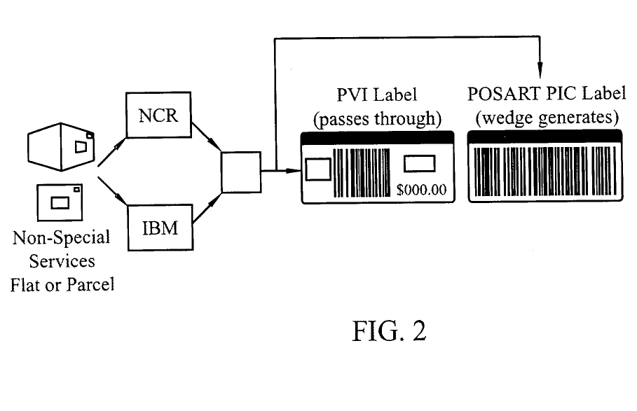

FIG. 3 depicts the flow plan of the system with a security camera interface in an alternative preferred embodiment.

FIG. 4 depicts the flow plan of the system with a security camera interface with multiple technology options

FIG. 5 depicts a barcoded label with content information.

### DETAILED DESCRIPTION OF THE PREFERRED EMBODIMENTS

Reference will now be made in detail to exemplary embodiments of the invention, examples of which are illustrated in the accompanying drawings. Wherever possible, the same reference numbers will be used throughout the drawings to refer to the same or like parts.

Due to increased national security concerns it has become necessary to establish new security and investigative capabilities in retail enters and automated retail vending mechanisms, these new capabilities must promote expedient criminal investigations and serve as deterrents against the use of the mail system and other similar systems as a conduit of malicious activities.

The strategy described herein will enable positive matching of postal products and services labeled with unique identifiers to the image of the customer purchasing the products and services. This process is not limited to postal products. The customer's image is captured through security cameras. Retail product identifiers and security footage are linked by correlating date, time, and location of the customer transaction. This association is then stored so that every retail transaction can be traced back to a corresponding customer image. In an alternate embodiment, data in addition to images may be linked to the footage; such data includes signatures, ID numbers, etc.

The unique mail piece identifiers instrumental to this program will also enable the tracking of retail mail pieces and purchased products and services throughout a supply chain network. These tracking features have the potential to inform facilities they have come in contact with micious products, or notify them of inbound suspect products.

This system and method can ultimately be applied to other forms of postal product sales and other retail infrastructures. With modifications to the stamp production process, individual stamps will be linked to the book and lot of stamps they comprise, and these lots will be associated to a vending machine or retail mechanism sales. Security cameras will capture vending machine or other retail mechanism sales employing the same positive product matching principle. A book of stamps will be associated to the image of the customer that buys them, and individual stamps within that book will be traced directly back to the customers image through the stamp book.

A biometrics identification technology can be coupled with this strategy to proactively identify customers, packages, and purchases that pose a potential threat. These mail products and services can then be singled out for inspection before entering the postal distribution network. Any product or service purchased by a customer can be flagged based on biometrics. The use of biometrics at a retail counter and retail mechanism can extend past the USPS infrastructure into other industries or similar companies.

An additional component of this system and method introduces a barcoded label to certain classes of mail pieces. The overall purpose of this label is to uniquely identify retail mail for the recording of security in retail window transactions.

This is just one unique barcode application, multiple other unique barcode and radio frequency identification technologies may also be used for this process.

Positive product matching to customers in the retail arena can significantly reduce investigation time. Within the United States Postal Service, positive product matching will allow for tracking, tracing, and isolation of suspicious packages as well as allow for quick investigation into suspicions purchases in both the postal arid other industries. Coupled with facial recognition software, this system and method will allow for suspect packages and purchases to be identified and isolated at their origin in their distribution network as opposed to a downstream point in the distribution network.

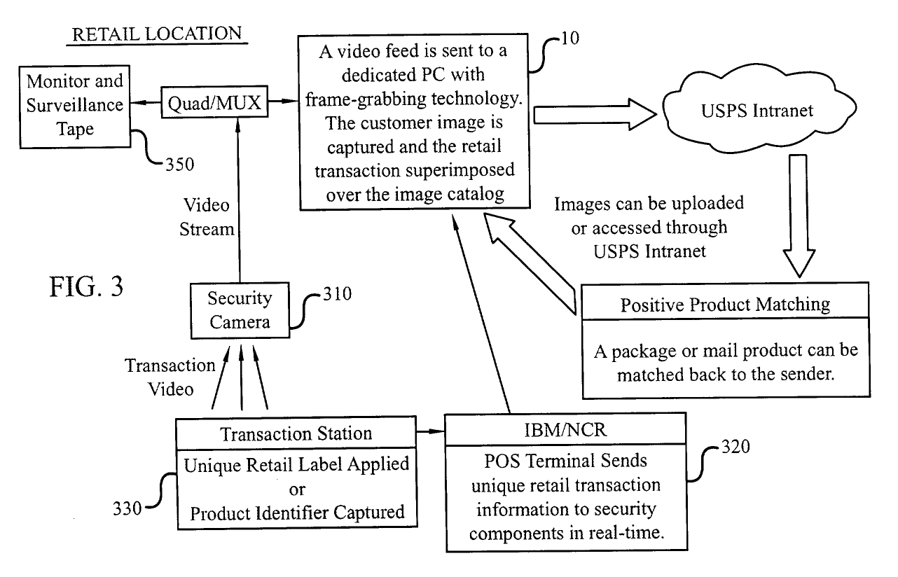

FIG. 3 provides a first preferred embodiment of the present invention. At a USPS retail location a security cam 310 records an image of a customer. A retail terminal 320 provides unique information related to the transaction. A unique retail label 330 is printed at the transaction site. The label may be applied to the mailpiece or other mail item. Data related to the image of the customer is passed via video stream to security computer 340. Transaction data related to the customer's transaction is also transmitted via data line to security computer 340. Security computer 340 in one embodiment combines the visual image data with transaction data to create a data set for storage. Image data may be obtained from real time video via frame grabbing technology. This information may be reviewed at security monitor 350 either in real or delayed time.

A security search of the image and transaction data may be performed. In a preferred embodiment biometric data relating to the image as well as transaction data is compared to a database containing data identifying suspect individuals. For example, biometric data received from the video image of the customer may be compared to images of suspect individuals. Similarly identifying information such as the customers name, address, drivers license number or social security number may also be compared to information stored on the suspect database. Where there is a match between customer information and the suspect database, the transaction is flagged for further attention. Thus, the mailpiece may be pulled from the mail system for further inspection or appropriate attention. The mailpiece originating with the suspect individual may be identified through the barcode label that was applied to the mailpiece at the retail counter.

For safety and security reasons it has become necessary to identify the retail inductor of a package or a mail piece so that it can be tracked back to the originating customer. In one embodiment of the invention this is accomplished by taking the image of the person delivering the package at the retail counter by a security camera. The image is captured, stored (i.e. analog or digitally compressed) and electronically linked to the uniquely defined bar code on a label. The captured video images related to the tracking label can be processed to match against a database of suspected persons. The image database contains biometric profiles of persons considered dangerous.

In another embodiment of the invention the uniquely identified label will identify the time and the retail origin location where it was presented should the package prove to contain suspicious contents. Thus the identity of the person can be established by images from the security camera.

Automated legacy mail processing equipment used throughout the postal distribution network may be updated to passively scan packages enroute. The scans may include the proposed label or other unique barcoded labels. Uniquely defined barcode tracking data will be stored in a repository (or repositories) that will host package and image tracking and reporting applications.

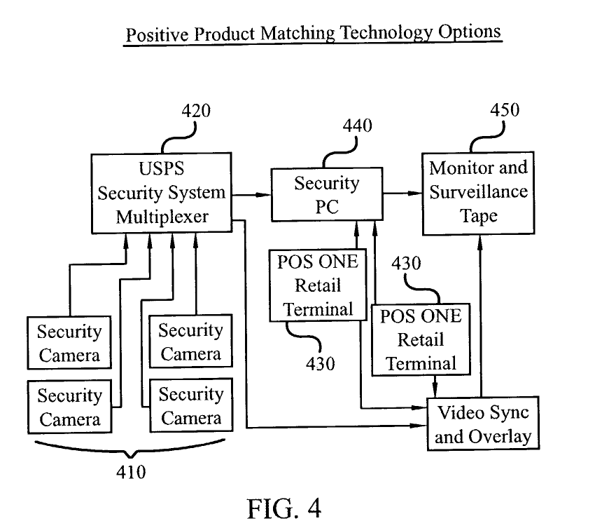

USPS has multiple closed-circuit TV security systems with cameras feeding video to multiplexers connected to time lapse VCRs and monitors. FIG. 4 is a depiction of this process. In the positive product matching process the customer's image is captured through security system cameras 410. Data passes through multiplexers 420. Information related to the customer's transaction is recorded at retail terminals 430. The customer's retail transaction is electronically linked with the customer's image and then cataloged. The linking takes place at security computer system 440. Review of suspect individuals and suspect transactions may take place at a remote security monitor 450. Review may be in a time delayed or real time mode. Positive product matching can be used with multiple different security setups beyond those found in the USPS environment.

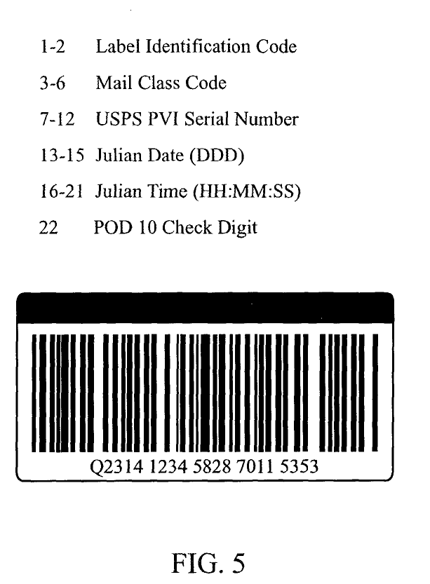

FIG. 5 depicts the USPS barcoded label that will be applied to mail pieces not receiving other unique identifiers. The data content of this barcoded label is as follows:

Label Identification Code

| | |
|---|---|
| (1 Alpha + overhead) | 1-2 |
| Mail Class Code | 3-6 |
| U.S. Pat. No. PVI Ser. No. | 7-12 |
| Julian Date (DDD) | 13-15 |
| Julian Time (HH:MM:SS) | 16-21 |
| Mod 10 Check Digit | 22 |

The system and process described is not limited to postal transactions, it can be used with any retail or non retail operation and is not restricted to over the counter or vending machines only. The principles described here can be adapted to various kinds of retail situations.

Products and services that may be used with the system and method include, but are not limited to stamps, envelopes, mail pieces, money orders and any other product or service sold by the United States Postal Service.

Retail mechanisms to be included in the present invention include detail windows, the Internet, vending machines, third party suppliers or any other mechanism customers use to purchase products or services.

Identification tools described above can include images, signatures, fingerprints and any other attribute or key that will allow a person, place or thing to be uniquely identified.

While preferred embodiments of this invention have been shown and described, modifications thereof can be made by one skilled in the art without departing from the spirit or teaching of this invention. The embodiments described herein are exemplary only and are not limiting. Many variations and modification of the system and apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims which follow, the scope of which shall include all equivalents of the subject matter of the claims.

Other embodiments consistent with the present invention will be apparent to those skilled in the art from consideration of the specification and practice of this invention disclosed herein. It is intended that the specification and examples be considered exemplary only, with the true scope of the invention being indicated by the following claims and equivalents.

What is claimed is:

1. A method of tracking information about the deliverer or purchase of products and services of a Postal or non-Postal product or service at the retail window operation or retail mechanism said method comprising:
taking an image of the customer;
electronically linking said image to a unique product identifier.

2. The method of claim 1 wherein said unique product identifier is a barcode.

3. The method of claim 2 wherein said unique product identifier is a 2D barcode.

4. The method of claim 1 further comprising the step of recording information from the customer including name, address, drivers license number, or social security number.

5. The method of claim 1 wherein said information comprises biometric facial recognition data captured from a digital image of the purchaser.

6. A method of providing mail security in connection with the use of a mail product or service comprising:
capturing an image of a person purchasing a product or service;
matching said image against databases of pictures of suspected persons; and
identifying mailpieces for further inspection where the mailer of said mailpiece matches a suspected person.

7. The method of claim 6 wherein said matching step further comprising matching based on biometric facial recognition data.

8. The method of claim 6 further comprising recording identification information including name, address, drivers license number, or social security number.

9. The method of claim 6 further comprising removing a mailpiece from the mail system that was deposited by an individual matching a suspect list.

10. A mailing label in barcode format comprising:
a label identification code;
a mail class code;
a Postal Service PVI Serial Number;
a Julian Date;
Julian Time; and
a MOD 10 check digit.

11. The mailing label of claim 10 wherein said label identification code occupies spaces 1-2 on said barcode.

12. The mailing label of claim 10 wherein said mail class code occupies spaces 3 to 6 of said barcode.

13. The mailing label of claim 10 wherein said Postal Service PVI Serial Number occupies spaces 7 to 12 of said barcode.

14. The mailing label of claim 10 wherein said Julian Date occupies spaces 13 to 15 of said barcode.

15. The mailing label of claim 10 wherein said Julian Time occupies spaces 16 to 21 of said barcode.

16. The mailing label of claim 10 wherein said Mod 10 check digit occupies space 22 of said barcode.
